(19) United States
(12) Patent Application Publication
(10) Pub. No.: US 2008/0069290 A1
(43) Pub. Date: Mar. 20, 2008

(54) Integrated monitoring method for nuclear device and system using the same

(75) Inventors: Jin-Ho Park, Yuseong-gu (KR); Doo-Byung Yoon, Seo-gu (KR); Young-Chul Choi, Geumjeong-gu (KR); In-Soo Koo, Yuseong-gu (KR); Chang-Ho Son, Geumjeong-gu (KR)

Correspondence Address: MCDERMOTT WILL & EMERY LLP, 600 13TH STREET, N.W., WASHINGTON, DC, 20005-3096, US

(73) Assignee: KOREA ATOMIC ENERGY RESERCH INSTITUTE

(21) Appl. No.: 11/889,705

(22) Filed: Aug. 15, 2007

(30) Foreign Application Priority Data
Aug. 17, 2006 (KR) 10-2006-0077853

(51) Int. Cl. G21C 17/00

(52) U.S. Cl. 376/259

(57) ABSTRACT

An integrated monitoring method and a system using the same which can monitor structural integrity or an operating state of a nuclear device are provided. One integrated analysis unit receives a plurality of signals in order to integrate, mutually exchange, and analyze from a plurality of heterogeneous sensors installed in the nuclear device. The integrated analysis unit may notify an operator with an alarm since an alarm unit may be adhered to the integrated analysis unit. Accordingly, the present invention may provide accurate, useful, and various information due to integration of the sensor signal while not increasing a number of installed sensors, manufacture a simulator by generating a database of the sensor signals, or use a past signal as data for an optimum design by researching and analyzing the past signal.

### CROSS-REFERENCE TO RELATED APPLICATION

This application claims the benefit of Korean Patent Application No. 10-2006-0077853, filed on Aug. 17, 2006, in the Korean Intellectual Property Office, the disclosure of which is incorporated herein by reference.

### BACKGROUND OF THE INVENTION

1. Field of the Invention

The present invention relates to an integrated monitoring method for a nuclear device and a system using the same, and more particularly, to an integrated monitoring method for a nuclear device and a system using the same which can exchange a heterogeneous sensor signal installed in the nuclear device and integratedly analyze the sensor signal, thereby providing accurate, useful, and various information due to integration of the sensor signal not increasing a number of installed sensors, manufacturing a simulator by generating a database of the sensor signals, or using a past signal as data for an optimum design by researching and analyzing the past signal.

2. Description of Related Art

The worst nuclear accident in history occurred in Chernobyl of the former Soviet Union on Apr. 26, 1986. The unprecedented radiation accident in which a core meltdown of a nuclear reactor occurred and much radioactive material was leaked was a result of Chernobyl technicians neglecting several safety procedures, and a chain reaction of the core could not be controlled.

Even though the number of fatalities due to the accident spreading fallout, referred to as ashes of death, was more than the fallout due to the atomic bomb dropped on Japan in 1945 by tens or hundreds of time is unsubstantiated, the Ukraine government announced in 1998 that the number of only dead was about 3,500. It is presumed that the number of people with injuries was hundreds of thousands or millions, and experts estimated that among them, several thousand victims would die of various cancers. Many deformed children were born, and infant mortality rate was increased. Since a surrounding environment was seriously affected, soil and underground sources of water supplies within about 32 km from the Chernobyl nuclear power plant are severely polluted by the radioactive material.

While a nuclear accident affecting off-site human life has yet to occur in Korea, damage is also serious when even a very minor accident of a nuclear plant occurs, and focuses social concerns.

Accordingly, nuclear safety cannot be emphasized enough, and a future safety-related law, and the like, are generally enacted or intensified. Therefore, an ability of monitoring structural integrity of a structure of a nuclear power plant is required to be improved.

Various sensors are currently adhered to a nuclear device in order to monitor the structural integrity, and the like. Research is currently under way in order to improve a function of the above-described monitoring system is related to a method of optimizing a location of sensors, or additionally installing a sufficient number of sensors.

However, since a sensor, a cable connecting the sensors, and a conduit are required to be replaced and installed when the sensor location is optimized, or a number of sensors is additionally increased, a problem in a cost aspect is generated, and a worker has difficulty in working for many hours in a radiation control area having a high radiation level. Accordingly, continuous improvement and replacement of the system are problematic.

Even though a vibration sensor, an acoustic detection sensor, a non-contact displacement sensor, an acceleration sensor, and the like, are installed in each appropriate location and are used in order to determine the structural integrity of the nuclear device, determining whether a foreign substance permeation, a crack, or a leak occurs, synthesizing and analyzing the sensor signals, or research on signal exchange or signal integration is insufficient. Accordingly, more accurate and meaningful information than existing information is acquired only by adding sensors. As a result of adding the sensors, additional costs due to sensor waste, reduction of work efficiency, safety problems due to work time accumulation, and the like, are generated.

Therefore, an integrated monitoring method for a nuclear device and a system using the same is required.

### BRIEF SUMMARY

An aspect of the present invention provides an integrated monitoring method for a nuclear device and a system using the same which can exchange a heterogeneous sensor signal installed in the nuclear device and integratedly analyze the sensor signal.

An aspect of the present invention also provides an integrated monitoring method for a nuclear device and a system using the same which can provide accurate, useful, and various information due to integration of a sensor signal while not increasing a number of sensors installed in the nuclear device.

An aspect of the present invention also provides an integrated monitoring method for a nuclear device and a system using the same which can cut work time, due to sensor addition, reduce work time in a radioactive environment, and improve safety of the nuclear device by providing a quick safety warning of the nuclear device for an operator.

An aspect of the present invention also provides an integrated monitoring method for a nuclear device and a system using the same which can perform an automated and accurate monitoring function of the nuclear device by integratedly acquiring and analyzing measured signals of various sensors.

An aspect of the present invention also provides an integrated monitoring method for a nuclear device and a system using the same which can manufacture a simulator by generating a database of measured signals of an integrated analysis unit, or use a past signal as data for an optimum design by researching and analyzing the past signal.

According to an aspect of the present invention, there is provided an integrated monitoring system for a nuclear device, the system including: a sensor unit; an integrated signal acquisition unit; and an integrated analysis unit.

The sensor unit includes a plurality of sensor modules being adhered to the nuclear device and sensing a heterogeneous signal. Also, the sensor unit includes: a first sensor module detecting an impact wave due to a foreign substance in an internal system of the nuclear device; a second sensor module detecting a leak or a leak in the system; a third sensor module detecting natural frequencies of vibrations of an internal structure of a nuclear reactor of the nuclear device; and a fourth sensor module detecting an abnormal vibration state of a frame and a rotating shaft of a reactor coolant pump in the nuclear device.

The first sensor module is a vibration sensor installed in an outside of a pressure boundary of the nuclear device, and the second module is an leak detection sensor corresponding to an Acoustic Emission (AE) sensor installed in the outside of the pressure boundary of the nuclear device. Also, the third sensor module detects the natural frequencies of vibrations of the internal structure of the nuclear reactor by analyzing a noise signal component of a neutron detector, and the fourth sensor module is a vibration sensor and non-contact displacement sensor.

The integrated signal acquisition unit is connected with the sensor unit and acquires a measured signals, and the integrated analysis unit is connected with the integrated signal acquisition unit, mutually exchanges the heterogeneous signal, and analyzes the heterogeneous signal. The sensor unit measures a vibration of the nuclear device, and frequency ranges measured by each sensor are different.

The system further includes: an alarm unit notifying an operator of an alarm when a numerical value in the integrated analysis unit is greater than or equal to a predetermined numerical value. The alarm unit provides at least one of an audible warning signal and a visible warning signal for an operator.

A number of the integrated signal acquisition units and a number of the integrated analysis units are equal to a number of sensor units, and the signal received from the integrated signal acquisition unit is respectively provided for a plurality of integrated analysis units. In this case, a change of a hardware aspect may be minimized, and an aspect of the present invention may be realized in a software aspect.

According to another aspect of the present invention, there is provided an integrated monitoring method of a nuclear device, the method including: providing a plurality of sensor modules sensing a heterogeneous signal for the nuclear device which performs power generation, material extraction, or a test by using nuclear energy; acquiring a plurality of signals generated from the plurality of sensor modules; notifying, by an alarm, when a numerical value of any one of the plurality of signals is greater than a predetermined numerical value; and exchanging and analyzing the plurality of signals.

Accordingly, the present invention can exchange a heterogeneous sensor signal installed in the nuclear device and integratedly analyze the sensor signal, thereby providing accurate, useful, and various information due to integration of the sensor signal while not increasing a number of installed sensors, manufacturing a simulator by generating a database of the sensor signals, or using a past signal as data for an optimum design by researching and analyzing the past signal.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a schematic view illustrating an integrated monitoring system for a nuclear device according to an exemplary embodiment of the present invention;

FIG. 2 is a schematic view illustrating a modified exemplary embodiment of the present invention;

FIG. 3 is a schematic view illustrating an integrated monitoring system for a nuclear device according to another exemplary embodiment of the present invention; and

FIG. 4 is a flowchart illustrating an integrated monitoring method according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

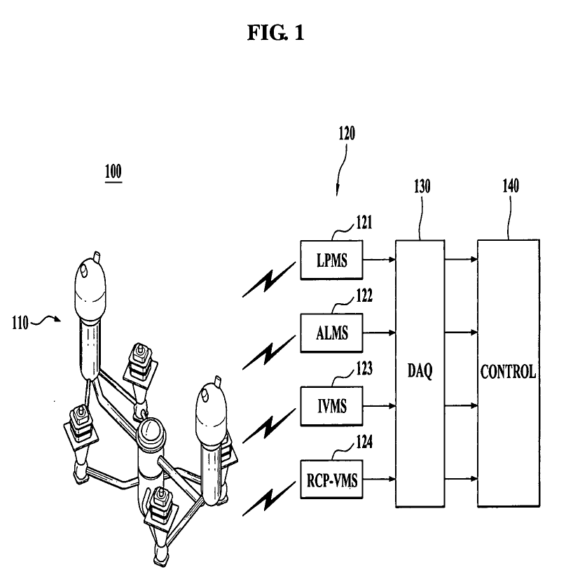

FIG. 1 is a schematic view illustrating an integrated monitoring system 100 for a nuclear device 110 according to an exemplary embodiment of the present invention. As illustrated in FIG. 1, the integrated monitoring system 100 includes the nuclear device 110, a sensor unit 120, an integrated signal acquisition unit 130, and an integrated analysis unit 140.

The nuclear device 110 may be a device for nuclear power generation, a device extracting a specific material by using nuclear energy, or a test device for a nuclear energy performance test. Also, the nuclear device 110 includes all devices generating a power, performing an experiment, and performing a processing by using a nuclear fuel.

The sensor unit 120 includes a plurality of heterogeneous sensor modules sensing a heterogeneous signal. The sensor unit 120 is described in detail below.

A first sensor module 121 may be a sensor module of a Loose Parts Monitoring System (LPMS). The LPMS denotes a system for detecting an impact wave due to a foreign substance in an internal system of the nuclear device by using a vibration sensor installed in an outside of a pressure boundary of a nuclear reactor. Existence or absence of the foreign substance, an impact location of the foreign substance, a mass of the foreign substance, and the like, may be monitored by using the LPMS.

The LPMS enables the structural integrity of the nuclear power plant to be secured by early detecting damage of a nuclear reactor system device and a structure. Specifically, the impact wave due to loose parts generation may be detected, and whether the loose parts exist may be evaluated. Also, online alarm generation, and the like, may be performed.

The second sensor module 122 may be a sensor module of an Acoustic Leak Monitoring System (ALMS). The ALMS is a system for detecting a leak and a crack in the primary pressure boundary of a nuclear reactor by using an Acoustic Emission (AE) sensor and a vibration sensor in an outside of a pressure boundary of the nuclear reactor. According to the determination of the crack or the leak by using the ALMS, a function of immediately shutdown the nuclear reactor, and the like, may be performed.

An ALMS sensor module may be installed on an external surface of the pressure boundary of the nuclear reactor system, enabling the system structure to be monitored for leaks and cracks. Also, by opening and closing a pressurizer safety valve (PSV), the leak, and the like, may be monitored. The ALMS may be configured to generate an online, real-time alarm in order to detect the leak or the crack, and to find a location and a degree of progress of the leak and the crack.

The third sensor module 123 may be a sensor module of an Internals Vibration Monitoring System (IVMS). The IVMS is a system for detecting natural frequencies of vibrations of an internal structure of the nuclear reactor by analyzing a noise signal component of a neutron detector. The structural integrity of the internal structure of the nuclear reactor may be monitored by using the IVMS.

The IVMS monitors a defect of a support condition of the internal structure of the nuclear reactor by analyzing a noise signal component of a neutron detector when the nuclear reactor is normally operated. The IVMS may secure the structural integrity of the nuclear power plant by early detecting an active defect of the internal structure of the nuclear reactor. The IVMS may monitor, online, and in real-time, a change of natural frequencies of vibrations of a Core Support Barrel (CSB) or a nuclear fuel channel.

The fourth sensor module 124 may be a sensor module of a Reactor Coolant Pump Vibration Monitoring System (RCP-VMS). The RCP-VMS denotes a system for detecting an abnormal vibration state of a frame and rotating shaft of a coolant pump in the nuclear reactor by using a vibration sensor and a non-contact displacement sensor. An alignment state of the rotating shaft, unbalanced condition, or the crack of shaft may be detected by using the RCP-VMS.

The RCP-VMS monitors an abnormal state of the rotation axis of the coolant pump in the nuclear reactor and a bearing unit by using a signal of the vibration sensor and the non-contact displacement sensor. A performance of the coolant pump may be evaluated by detecting an abnormal motion or instability due to oil whirl or oil whip, or detecting abrasion or a defect of the bearing unit, and the like.

Each sensor module 121, 122, 123, and 124 is connected with one integrated signal acquisition unit 130. The integrated signal acquisition unit 130 may be a Data Acquisition (DAQ) board. The integrated signal acquisition unit 130 may include each receiving module receiving information from each sensor module on one board, however, the integrated signal acquisition unit 130 may independently configure the receiving module.

The integrated signal acquisition unit 130 is connected with the integrated analysis unit 140. All signals received from each sensor module are integrated in the integrated analysis unit 140 and are analyzed. The above-described operation may be performed since measured signals of each sensor module include information of each different system, the information is mutually complemented by using the signal, and accuracy of a monitoring system may be improved.

The integrated signal acquisition unit 130 amplifies the signal inputted from sensors installed in the nuclear device corresponding to a structural integrity evaluation object, applies a frequency band filter, performs an analog-to-digital (AD) converter function converting an analog signal into a digital signal, and performs a processing so that the integrated analysis unit 140 may use the signal.

Specifically, each sensor 121, 122, 123, 124, and the like, are similar in that all sensors measure a vibration of a monitoring object structure, however, each sensor 121, 122, 123, 124, and the like, have a feature that frequency ranges of vibrations measured according to a unique feature of each sensor are different. Specifically, an accelerometer sensor generally used for the LPMS generally measures a vibration less than or equal to 200 kHz in order to monitor loose parts, and an AE sensor generally used for the ALMS generally measures a vibration less than or equal to 2 MHz in order to detect the leak.

Each sensor may be used for an identical purpose even though the measured frequency bands are different. Specifically, when the loose parts are generated, the vibration of the structure may be detected by the LPMS and the ALMS. Accordingly, when the information measured by the LPMS and the information measured by the ALMS are additionally used for estimating the location and the mass of the loose parts, a number of LPMS sensors may be naturally increased, and accuracy of the analysis may be improved.

Also, since some sensors of the RCP-VMS and the ALMS are accelerometers corresponding to sensors of a type identical to the LPMS, these have an effect of having additional sensors installed for the LPMS in the monitoring object structure of the nuclear device. Therefore, analysis accuracy of the LPMS may be improved.

Accordingly, the structural integrity of the nuclear device used for the nuclear power plant may be automatically monitored and checked by integratedly acquiring and analyzing all signals measured by various sensors, similar to the present invention.

Also, a simulator may be manufactured by generating a database of the signal, or a past signal may be used as data for an optimum design by researching and analyzing the past signal. The integrated analysis unit 140 may be connected with an auxiliary memory medium to build a database.

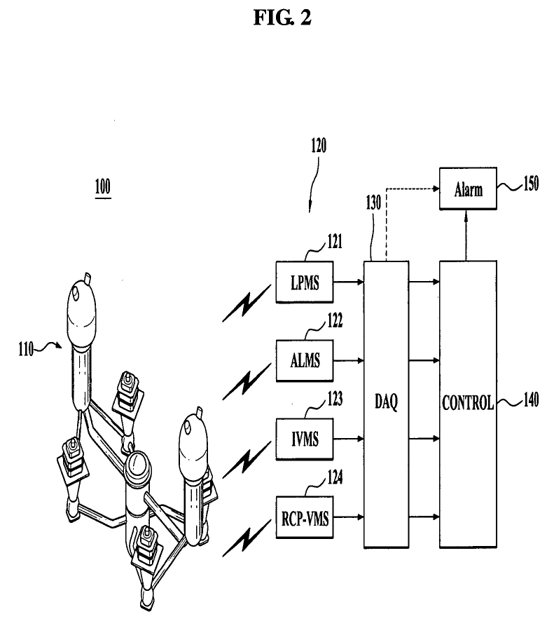

FIG. 2 is a schematic view illustrating a modified exemplary embodiment of the present invention. As illustrated in FIG. 2, an alarm unit 150 is adhered to an integrated analysis unit 140. When the present modified exemplary embodiment of the present invention is described, redundant details of the previous exemplary embodiment of the present invention are omitted for simplifying a description.

The alarm unit 150 generates a voice, a sound, or light for providing a perceptible effect, and notifies a user of an alarm. The alarm unit 150 is connected with the integrated analysis unit 140, and may generate the alarm after sensing an abnormal phenomenon in the nuclear device by the signal integratedly analyzed by the integrated analysis unit 140.

According to another scheme, the alarm unit 150 may be connected with the integrated signal acquisition unit 130 acquiring the signal of the sensor unit 120. In this case, the alarm unit 150 may generate an audible alarm, and the like, when a measured value of at least one of the sensor modules 121, 122, 123, and 124 included in the sensor unit 120 is greater than a predetermined allowable value.

The integrated analysis unit 140 performs a basic analysis of all signals supplied by the integrated signal acquisition unit 130. Also, when monitoring structural integrity of an object structure for loose parts, a leak and a crack of a pipe and a valve, a change of a support condition of the CSB and a vibration feature, and a high vibration of a reactor coolant pump are generated, the integrated analysis unit 140 transmits an alarm signal to the alarm unit 150, and notifies an operator located in a control room by the alarm unit 150.

Also, the integrated analysis unit 140 may receive all signals acquired from measurements of the nuclear device and perform an integrated detailed analysis of the signals. As a result of the integrated detailed analysis, the integrated analysis unit 140 may perform estimation of a location and a mass of the loose parts, leak location estimation, leak amount estimation, an estimation of the support condition of the CSB and a support condition of a nuclear fuel assembly, a high-vibration analysis and a high-vibration cause analysis of the reactor coolant pump, and the like, in an online method. Also, the integrated analysis unit 140 integratedly diagnoses the structural integrity of the integrity evaluation object structure based on the above-described detailed signal analysis result, generates a database of the integrated analysis result, and outputs a monitoring and check result as required.

The integrated analysis unit 140 may be configured to provide a feedback signal for the nuclear device and enable the nuclear device to be stopped immediately or after predetermined time.

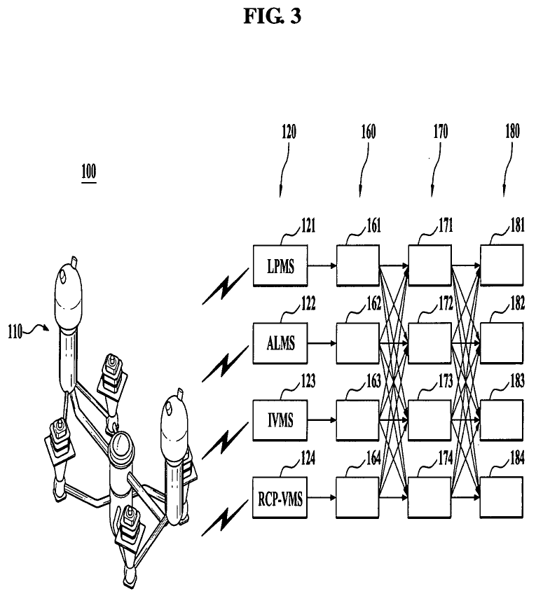

FIG. 3 is a schematic view illustrating an integrated monitoring system for a nuclear device according to another exemplary embodiment of the present invention. A plurality of signal acquisition units 160 respectively connected and installed along with a sensor unit 120, an alarm unit 170, and an analysis unit 180 are illustrated in FIG. 3. Specifically, each sensor module 121, 122, 123, and 124 is connected to a corresponding signal acquisition module 161, 162, 163, and 164, each signal acquisition module 161, 162, 163, and 164, is connected with each alarm module 171, 172, 173, and 174, and each alarm module 171, 172, 173, and 174, is connected with each analysis module 181, 182, 183, and 184.

The signal inputted from each signal acquisition module 161, 162, 163, and 164 is connected with each alarm module 171, 172, 173, and 174. Also, the signal received and processed by each alarm module 171, 172, 173, and 174 is shared by each analysis module 181, 182, 183, and 184.

The above-described configuration is an exemplary embodiment of the present invention which can minimize a change of an existing hardware and change a configuration into a software aspect, thereby achieving a purpose of the present invention without difficulty of the configuration including a change of installation, and the like.

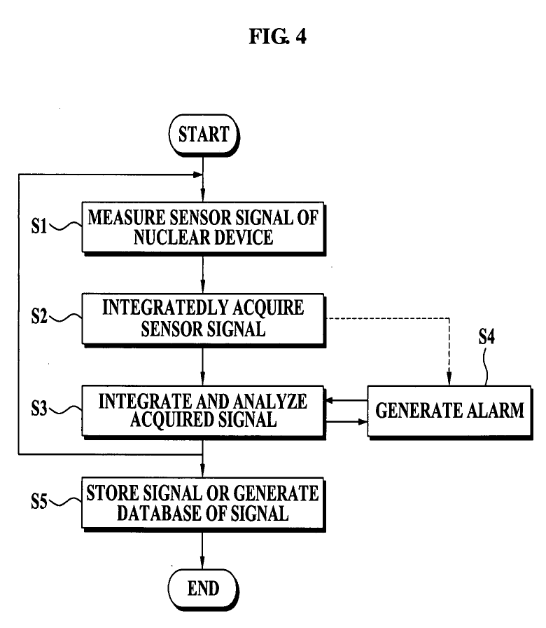

FIG. 4 is a flowchart illustrating an integrated monitoring method according to an exemplary embodiment of the present invention. As illustrated in FIG. 4, after each sensor module is installed in a nuclear device, a sensor signal is measured in operation S1. The received sensor signal is integratedly acquired by using a DAQ board, and the like, in operation S2. In this instance, integrated acquisition of the sensor signal may be configured to be exchanged in the software aspect after configuring each separate hardware and separately acquiring the signal as illustrated in FIG. 3.

Next, the acquired signal by the integrated analysis unit, and the like, is integrated and analyzed in operation S3. In this instance, when the signal which can generate an alarm according to a predetermined condition is sensed, the alarm is generated and an operator, and the like, are notified of the alarm in operation S4. Also, as described above, when a numerical value in one sensor is greater than a predetermined numerical value denoting danger before a subsequent analysis operation of the integrated analysis unit after integratedly acquiring the sensor signal, the present invention may be configured to immediately generate the alarm in operation S4.

Next, when the analysis is completed, the signal is stored, or a database of the signal is generated in operation S5.

The nuclear device is described as an example in the present invention, however, the present invention may be applied to all structures and devices required for monitoring, checking, and evaluating the structural integrity in a range where an aspect of the present invention is not changed.

According to the above-described exemplary embodiments of the present invention, an integrated monitoring method for a nuclear device and a system using the same may exchange a heterogeneous sensor signal installed in the nuclear device and integratedly analyze the sensor signal.

Also, according to the above-described exemplary embodiments of the present invention, an integrated monitoring method for a nuclear device and a system using the same may provide accurate, useful, and various information due to integration of a sensor signal while not increasing a number of sensors installed in the nuclear device.

Also, according to the above-described exemplary embodiments of the present invention, an integrated monitoring method for a nuclear device and a system using the same may cut work time, due to sensor addition, reduce work time in a radioactive environment, and improve safety of the nuclear device by providing a quick safety warning of the nuclear device for an operator.

Also, according to the above-described exemplary embodiments of the present invention, an integrated monitoring method for a nuclear device and a system using the same may perform an automated and accurate monitoring and check function of the nuclear device by integratedly acquiring and analyzing a measurement signals of various sensors.

Also, according to the above-described exemplary embodiments of the present invention, an integrated monitoring method for a nuclear device and a system using the same may manufacture a simulator by generating a database of measurement signals of an integrated analysis unit, or use a past signal as data for an optimum design by researching and analyzing the past signal.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An integrated monitoring system for a nuclear device which performs power generation, material extraction, or a test by using nuclear energy, the system comprising:
a sensor unit including a plurality of sensor modules being adhered to the nuclear device and sensing a heterogeneous signal;
an integrated signal acquisition unit being connected with the sensor unit and acquiring a measured signals; and
an integrated analysis unit being connected with the integrated signal acquisition unit, mutually exchanging the heterogeneous signal, and analyzing the heterogeneous signal.

2. The system of claim 1, wherein the sensor unit comprises:
a first sensor module detecting an impact wave due to a foreign substance in an internal system of the nuclear device;
a second sensor module detecting a leak or a crack in the system;
a third sensor module detecting a natural frequencies of vibrations of an internal structure of a nuclear reactor of the nuclear device; and
a fourth sensor module detecting an abnormal vibration state of a frame and rotating shaft of a coolant pump in the nuclear device.

3. The system of claim 2, wherein the first sensor module is a vibration sensor installed in an outside of a pressure boundary of the nuclear device.

4. The system of claim 2, wherein the second module is an acoustic detection sensor corresponding to an Acoustic Emission (AE) sensor installed in an outside of a pressure boundary of the nuclear device.

5. The system of claim 2, wherein the third sensor module detects the natural frequencies of vibrations of the internal structure of the nuclear reactor by analyzing a noise signal component of a neutron detector.

6. The system of claim 2, wherein the fourth sensor module is a vibration sensor and non-contact displacement sensor.

7. The system of claim 1, wherein the sensor unit measures a vibration of the nuclear device, and frequency ranges measured by each sensor are different.

8. The system of claim 1, further comprising:
an alarm unit notifying an operator of an alarm when a numerical value in the integrated analysis unit is greater than or equal to a predetermined numerical value.

9. The system of claim 1, wherein the alarm unit provides at least one of an audible warning signal and a visible warning signal for an operator.

10. The system of claim 1, wherein the integrated analysis unit includes an auxiliary memory medium, and generates a database of the analyzed or measurement signals.

11. The system of claim 1, wherein a number of the integrated signal acquisition units and a number of the integrated analysis units are equal to a number of sensor units, and the signal received from the integrated signal acquisition unit is respectively provided for a plurality of integrated analysis units.

12. An integrated monitoring method of a nuclear device, the method comprising:
providing a plurality of sensor modules sensing a heterogeneous signal for the nuclear device which performs power generation, material extraction, or a test by using nuclear energy;
acquiring a plurality of signals generated from the plurality of sensor modules;
notifying, by an alarm, when a numerical value of any one of the plurality of signals is greater than a predetermined numerical value; and
exchanging and analyzing the plurality of signals.

13. The method of claim 12, wherein the providing provides a first sensor module detecting an impact wave due to a foreign substance in an internal system of the nuclear device;
a second sensor module detecting a leak or a crack in the system;
a third sensor module detecting a natural frequencies of vibrations of an internal structure of a nuclear reactor of the nuclear device; and
a fourth sensor module detecting an abnormal vibration state of a frame and rotating shaft of a coolant pump in the nuclear device.

14. The method of claim 12, wherein the plurality of sensor modules measures a vibration of the nuclear device, and frequency ranges measured by each sensor are different.

15. The method of claim 12, wherein the notifying provides at least one of an audible warning signal and a visible warning signal for an operator.

16. The method of claim 12, wherein the exchanging and analyzing further comprises:
generating a database of the analyzed signal or measured signal.
